(19) United States
(12) Patent Application Publication
(10) Pub. No.: US 2010/0017822 A1
(43) Pub. Date: Jan. 21, 2010

(54) METHOD OF DISPLAYING ELECTRONIC PROGRAM GUIDE AND APPARATUS USING THE SAME

(75) Inventor: Sung Soo Kim, Gumi-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/307,530

(22) PCT Filed: Mar. 23, 2007
(86) PCT No.: PCT/KR07/01426

§ 371 Date: Jul. 6, 2009

(30) Foreign Application Priority Data
Jul. 6, 2006 (KR) 10-2006-0063377

(51) Int. Cl. H04N 5/445; H04N 7/173

(52) U.S. Cl. 725/40; 725/134; 348/563; 725/133

(57) ABSTRACT

A method and apparatus for displaying an electronic program guide in a television receiver provided with a PVR function enhance user convenience by providing information of a program recorded and stored in the television receiver as well as information of programs currently broadcast or scheduled to be broadcast. The method of controlling a receiver includes steps of extracting electronic program guide (EPG) information from a received broadcast signal, the EPG information indicating a broadcasting schedule for a plurality of broadcast programs; searching at least one broadcast program of the plurality of broadcast programs, the searched at least one broadcast program corresponding to a temporary storage of the received broadcast signal in a storage device enabling a time-shift function; and constructing an EPG in which the searched at least one broadcast program is visually distinguishable from other broadcast programs of the plurality of broadcast programs.

### TECHNICAL FIELD

The present invention relates to a television receiver having a personal video recorder (PVR) function, and more particularly, to a method and apparatus for displaying an electronic program guide (EPG) in such a television receiver. Although the present invention is suitable for a wide scope of applications, it is particularly suitable for providing information of a recorded and stored program together with a displayed EPG.

### BACKGROUND ART

In digital television broadcasting, a broadcast signal is made up of video, audio, and data streams and typically includes additional information that is associated with the programming, i.e., content, of the broadcast signal. This additional information includes information of an electronic program guide (EPG) providing the viewer with a variety of information relevant to the broadcast signal. The EPG information is included in resource and subscriber management system (RSMS) data, which consists of program-specific and other information.

Display of an EPG image may be requested by the user while a broadcast program is being viewed, and the displayed information may include a program identifier (e.g., a title), a start time, a runtime, a program rating, etc. The display is typically arranged in a grid-like configuration resembling an ordinary program guide that may appear in a television periodical or daily newspaper, whereby detailed programming information is arrayed according to program, including programs that are currently broadcast and programs that are scheduled to be broadcast in the near future. To facilitate viewer identification of relevant programming, a specific block of the grid may be highlighted, that is, visually distinguished from all other programs of the guide, whereby the highlighted block corresponds to a current time slot of the tuned channel.

In a contemporary method of displaying an electronic program guide, however, the displayed information is limited to relatively current and near future programming. That is, beyond very recent programming, such as the time slot of a program immediately preceding the current program, there is no provision for an examination of past programming, i.e., broadcast program history. Moreover, such an EPG displaying method is limited to broadcast programs that are being received by the television receiver as part of a transmitted broadcast signal. Therefore, in a television receiver provided with a PVR function, execution of a specific recording list menu is necessary to verify information pertaining to a program that has been selectively recorded by a user or has been temporarily stored to perform a time-shift function.

### DISCLOSURE OF INVENTION

Accordingly, the present invention is directed to a method and apparatus for displaying an electronic program guide in a television receiver provided with a PVR function that substantially obviate one or more of the problems due to limitations and disadvantages of the related art.

An object of the present invention is to provide a method and apparatus for displaying an electronic program guide in a television receiver provided with a PVR function, which enhances user convenience by providing information of a program recorded and stored in the television receiver as well as information of programs currently broadcast or scheduled to be broadcast.

Another object of the present invention is to provide a method and apparatus for displaying an electronic program guide in a television receiver provided with a PVR function, which enables a user to observe visually distinguished blocks of a grid to verify whether a broadcast signal has been permanently stored or is being temporarily stored for a time-shift function.

Another object of the present invention is to provide a method and apparatus for displaying an electronic program guide in a television receiver provided with a PVR function, which provides a user, via an EPG image, with accurate channel information and detailed time information, to facilitate accurate identification of a received stream that has been temporarily stored for a time-shift function and to facilitate identification, selection, and playback of a specific program that has been permanently stored according to an earlier user selection.

Additional features and advantages of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the present invention, as embodied and broadly described, there is provided a method of controlling an EPG receiver. The method comprises extracting electronic program guide (EPG) information from a received broadcast signal, the EPG information indicating a broadcasting schedule for a plurality of broadcast programs; searching at least one broadcast program of the plurality of broadcast programs, the searched at least one broadcast program corresponding to a temporary storage of the received broadcast signal in a storage device enabling a time-shift function; and constructing an EPG in which the searched at least one broadcast program is visually distinguishable from other broadcast programs of the plurality of broadcast programs. The above searching may include first and second searching steps, wherein the first searching searches at least one broadcast program corresponding to a permanent storage of the received broadcast signal in a first storage device and wherein the second searching searches at least one broadcast program corresponding to a temporary storage of the received broadcast signal in a second storage device enabling a time-shift function, such that in the constructed EPG, the first searched at least one broadcast program, the second searched at least one broadcast program, and other broadcast programs of the plurality of broadcast programs are visually distinguishable from one another.

According to another aspect of the present invention, there is provided a receiver suitable for executing the method. The receiver of the present invention may include a digital television receiver, capable of receiving EPG information, that is further provided with a PVR function.

It is to be understood that both the foregoing general description and the following detailed description are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this specification, illustrate embodiment(s) of the invention and together with the description serve to explain the principles of the invention. In the drawings:

FIG. 1 is a schematic block diagram of a television receiver according to the present invention;

FIG. 2 is a flowchart of a method of displaying an electronic program guide according to the present invention; and

FIGS. 3A and 3B are exemplary diagrams of an EPG screen displayed by a television receiver adopting the present invention.

### BEST MODE FOR CARRYING OUT THE INVENTION

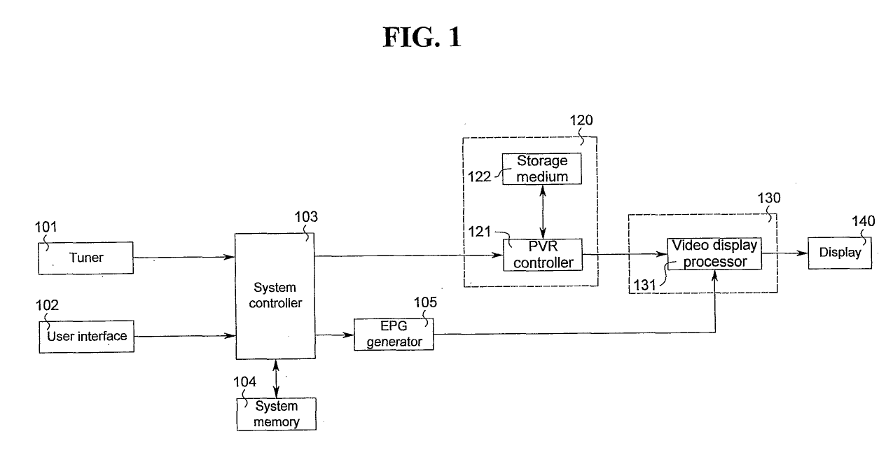

Referring to FIG. 1, a television receiver according to the present invention is provided with a PVR unit capable of storing and reproducing data. The PVR unit includes a storage device, such as a hard disc drive including a hard disc, serving as a storage medium for storing a received broadcast program (broadcast signal or stream) and thereby providing means for temporary storage of the broadcast signal to enable a time-shift function as well as permanent storage of the received broadcast signal according to a user selection for recording. The television receiver further includes a tuner 101 for performing a broadcast channel tuning according to a user operation of a user interface 102 and under control of a system controller 103 for controlling the overall system of the television receiver overall; a system memory 104 for storing EPG information; an EPG generator 105, which may include an on-screen display (OSD) generator, for generating an EPG according to EPG information extracted from additional information included in a received broadcast signal; and a PVR unit 120 including a PVR controller 121 and a storage medium 122.

The tuner 101 may be configured so that the received broadcast signal as described herein includes an external input signal or analog broadcast signal received via a secondary tuner or auxiliary input port. The received broadcast signal, which includes EPG information, is provided to the system controller 103 and is conventionally processed, for example, according to standard digital television reception and undergoes encoding (e.g., MPEG encoding) for PVR storage. Thus, the video, audio, and data streams of the received broadcast signal are decoded and provided to an audio/video processor 130 including a video display processor 131 for processing a video signal from the PVR controller 121 while superposing EPG image data output from the EPG generator 105. The PVR controller 121 may perform a switching function so that the received broadcast signal may be selectively provided to the storage medium or passed directly the video display processor 131 for display via a display 140.

The user interface 102, which may be a remote controller or a local keypad, enables an input of an EPG display request signal to the system controller 103. That is, in response to an EPG display request made by a user, the system controller 103 extracts electronic program guide (EPG) information from a received broadcast signal. The EPG information indicates a broadcasting schedule for a plurality of broadcast programs. Then, based on the extracted information, the system controller 103 searches at least one broadcast program of the plurality of broadcast programs. Then, under control of the system controller 103, the EPG generator 105 constructs, using image (OSD) data, an EPG in which the searched at least one broadcast program is visually distinguishable from other broadcast programs of the plurality of broadcast programs.

The searching performed by the system controller 103 may include first and second searching steps, wherein the first searching searches at least one broadcast program corresponding to a permanent storage of the received broadcast signal in a first storage device and wherein the second searching searches at least one broadcast program corresponding to a temporary storage of the received broadcast signal in a second storage device enabling a time-shift function. In doing so, the constructed EPG visually distinguishes the first searched at least one broadcast program, the second searched at least one broadcast program, and other broadcast programs of the plurality of broadcast programs from one another.

The system controller 103 also determines whether the PVR unit 120 contains the data of a recorded and stored program and controls the EPG generator accordingly, to construct an EPG image including grid blocks corresponding to the above visually distinguishable programs. That is, the constructed EPG image includes a plurality of blocks arranged serially according broadcast program, thereby forming a grid. Data of the thus-constructed EPG image is stored in the system memory 103. This EPG image may be displayed on a screen of the display 140 in accordance with a user request or output to a display device separate from the receiver.

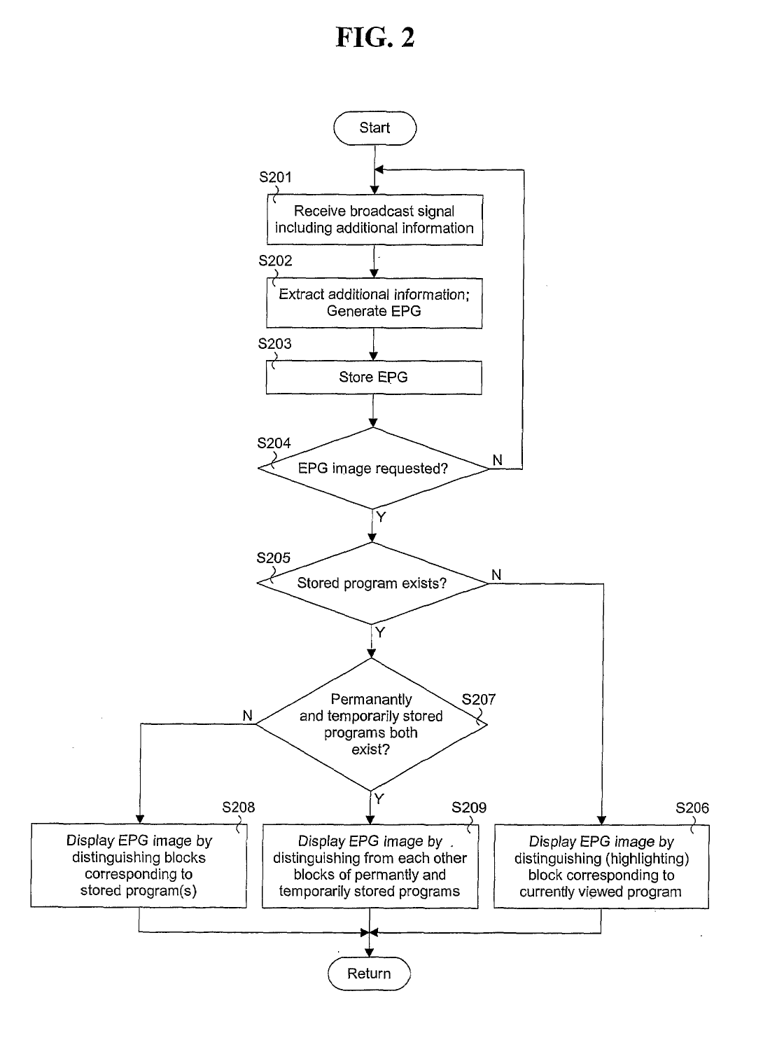

Referring to FIG. 2, illustrating a method of displaying an electronic program guide according to the present invention, a television receiver provided with a PVR function receives a broadcast signal including additional information (S201). The system controller 103 extracts the additional information from the received broadcast signal, and in particular, extracts a set of EPG information based on the additional information included in the broadcast signal by the broadcaster, so that the EPG generator 105 may generate an EPG according to the extracted information (S202). The EPG information, which indicates a broadcasting schedule for a plurality of broadcast programs, is then stored in the system memory 104 (S203). The steps S201 is to S203 may be repeated, for example, periodically, while a broadcast program is being viewed on a tuned channel. Thus, the stored EPG information may be updated to reflect the status of a currently broadcast signal, so that in the event of an EPG image request being input via the user interface 102 a search may be performed on current EPG information.

That is, subsequent to the storage of EPG information, and in response to an EPG image request input via the user interface 102 (S204), the system controller 103 searches the plurality of broadcast programs to determine whether at least one of the programs corresponds to a broadcast program stored in the PVR 120 (S205). If no such program is found, the system controller 103 controls the EPG generator 105 so that an EPG image is displayed on the display 140 by simply highlighting the grid block corresponding to the currently viewed program and thereby distinguishing it from all other programs (S206). Here, it should be appreciated that a current search corresponds to a search of broadcast programs of the EPG information included in a currently received broadcast signal and determines whether one or more such broadcast programs have been stored in the PVR 120 and determines the type of stored program. That is, it is determined whether the searched program is either one or both of a permanently stored program and a temporarily stored program, where a permanently stored program is a broadcast signal that has been selectively recorded by a user and thus stored in the storage medium 122 for later playback, as desired by a user, and where a temporarily stored program is a broadcast signal that is stored by the PVR controller 121 for executing a time-shift function and typically corresponds to only a select portion of a broadcast program. Such temporary storage may, for example, correspond to less than two hours of the received broadcast signal.

On the other hand, if it is determined by the search that one or more broadcast programs have been stored in the PVR 120, the system controller 103 determines whether the stored programs include at least one each of a permanently stored program and a temporarily stored program (S207). In doing so, it may be determined that the stored programs include only permanently stored programs or only temporarily stored programs, that is, no simultaneous storage of both types. Accordingly, if it is determined that the storage medium 122 contains only permanently stored programs, i.e., excluding any temporarily stored programs, the system controller 103 controls the EPG generator 105 so that an EPG image is displayed on the display 140 by distinguishing the block or blocks corresponding to the permanently stored programs from all other programs; similarly, if it is determined that the storage medium 122 contains only temporarily stored programs, i.e., excluding any permanently stored programs, the system controller 103 controls the EPG generator 105 so that an EPG image is displayed on the display 140 by distinguishing the block or blocks corresponding to the temporarily stored programs from all other programs (S208). Meanwhile, it may in the alternative be determined that the stored programs include both types, i.e., at least one of each type, in which case the system controller 103 controls the EPG generator 105 so that an EPG image is displayed on the display 140 by distinguishing from each other all blocks corresponding to the permanently stored program(s) and all blocks corresponding to the temporarily stored program(s) (S209). In either case, the grid block corresponding to the program currently viewed by the user may itself also be distinguished, i.e., highlighted. According to the present invention, distinguished blocks may use any available display characteristic providing a visual differentiation with respect to adjacent blocks, such as a background color or outline shape of the relevant block or blocks.

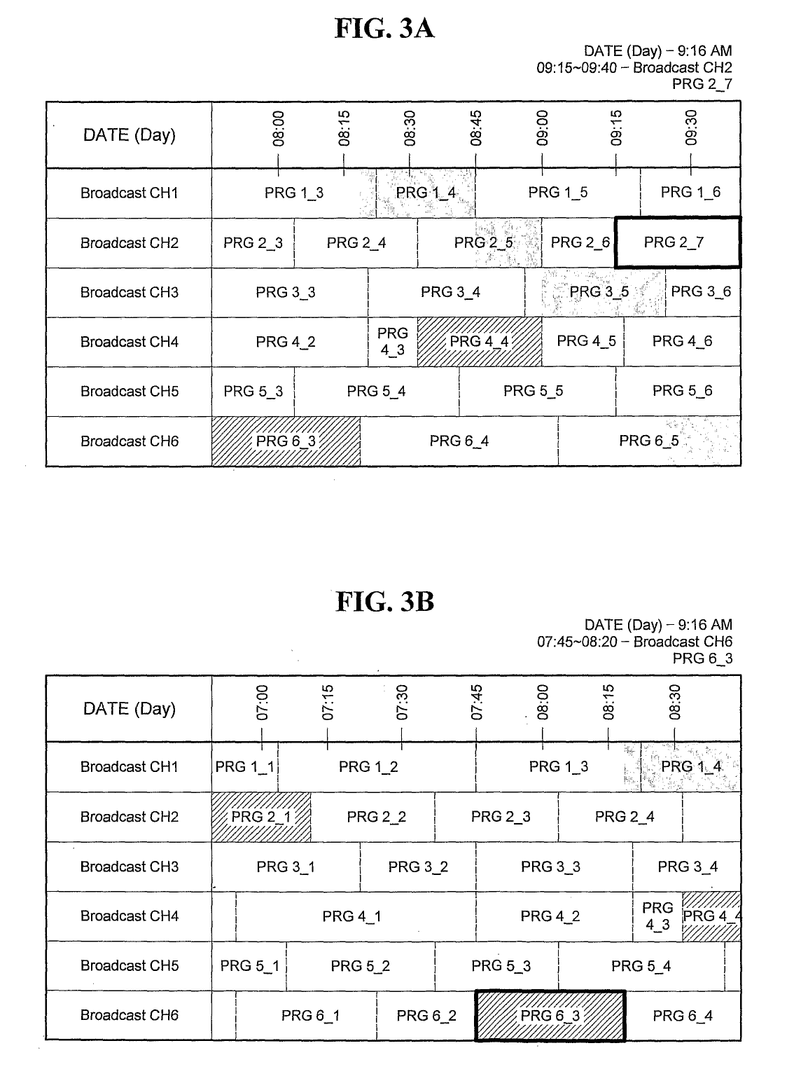

Once an EPG image is displayed according to the method of FIG. 2, the user may manipulate (move) the highlighted block as a curser. In doing so, the displayed contents of the entire EPG image is shifted within a viewable window of a screen of the display 140, thereby tracking the shifting of the highlighted block. That is, as the user shifts the highlighting of a block to the left or right, the system controller 103 correspondingly shifts the displayed portion of an EPG image by controlling the EPG generator 105 to regenerate the EPG image as necessary, so that program information selectively stored by the user may be viewed, enabling the user to verify recorded and stored program information, reserved-recording program information, and detailed information of programs that have been broadcast or have yet to be broadcast. Accordingly, as the user shifts the location of the highlighting of a block leftward with respect to the EPG image, more past programming information comes into view, and as the user shifts the location of the highlighting of a block rightward with respect to the EPG image, more future programming information comes into view, whereby the EPG generator 105 under control of the system controller 103 generates new EPG image information that gradually appears on the left or right side of the EPG image, while a corresponding amount of the original EPG image information disappears on the opposite side. This shifting and tracking of an EPG image is illustrated in FIGS. 3A and 3B.

Referring to FIG. 3A, depicting an exemplary EPG screen displayed by a television receiver adopting the present invention, an EPG image is displayed according to a user request, i.e., an EPG image request input via the user interface 102, to include blocks of a grid corresponding to broadcast programs, which are visually distinguished in accordance with a storage sequence and a storage length of the searched at least one broadcast program stored in the storage medium 122. In the example as shown, the storage medium 122 of the PVR 120 contains both types of stored programs, namely, permanently stored programs indicated by hashed blocks and including broadcast programs PRG 4_4 and PRG 6_3 and temporarily stored broadcast programs indicated by shaded blocks and including a stream (broadcast signal) received from 8:15 AM to 09:40 AM on four different channels in sequence, i.e., broadcast channels CH1, CH2, CH3, and CH6. At the same time, a current broadcast program PRG 2_7 is highlighted as indicated by a bold outline. Thereafter, as in the exemplary EPG screen of FIG. 3B, the highlight has been moved by the user to the left, i.e., into the past, to rest on the permanently stored broadcast program PRG 6_3, whereby another permanently stored program comes into view, namely, a broadcast program PRG 2_1, which is even earlier than the broadcast program PRG 6_3 and may in turn be selected, by highlighting its block, so that the user may verify its detailed information, recording status, etc.

### INDUSTRIAL APPLICABILITY

By adopting the present invention, user convenience is enhanced by providing information of a program recorded and stored in a television receiver provided with a PVR function as well as information of programs currently broadcast or scheduled to be broadcast. That is, an electronic program guide display according to the present invention facilitates user confirmation of the information for a program currently broadcast or to be broadcast in the future and the information of programs recorded and stored using the PVR function. In addition, accurate channel information and detailed time information can be obtained via an EPG image. The user observes visually distinguished blocks of a grid, i.e., the EPG image, to verify whether a corresponding program (broadcast signal) has been permanently stored, for example, according to an earlier user selection, or has been temporarily stored such that a time-shift function may be utilized. In the event of a temporarily stored broadcast signal, the visually distinguished blocks of the grid greatly facilitate a user's accurate identification of a received stream that has been so stored. In the event of permanent storage, the present invention facilitates identification, selection, and playback of a specific program.

While the present invention has been described and illustrated herein with reference to one or more preferred embodiments, it will be apparent to those skilled in the art that various modifications can be made in the present invention without departing from the spirit or scope of the invention. Thus, it is intended that the present invention covers such modifications provided they come within the scope of the appended claims and their equivalents.

What is claimed is:

1. A method of controlling a receiver, the method comprising:
extracting electronic program guide (EPG) information from a received broadcast signal, the EPG information indicating a broadcasting schedule for a plurality of broadcast programs;
searching at least one broadcast program of the plurality of broadcast programs, the searched at least one broadcast program corresponding to a temporary storage of the received broadcast signal in a storage device enabling a time-shift function; and
constructing an EPG in which the searched at least one broadcast program is visually distinguishable from other broadcast programs of the plurality of broadcast programs.

2. The method of claim 1, wherein the searched at least one broadcast program is visually distinguished from other broadcast programs in accordance with a storage sequence and a storage length of the searched at least one broadcast program stored in the storage device.

3. The method of claim 1, further comprising:
displaying the constructed EPG on a screen of the receiver in accordance with a user request.

4. The method of claim 1, further comprising:
outputting the constructed EPG to a display device separate from the receiver in accordance with a user request.

5. The method of claim 1, wherein the temporary storage corresponds to less than two hours of the received broadcast signal.

6. The method of claim 1, further comprising:
storing the constructed EPG in a memory.

7. The method of claim 1, wherein the constructed EPG includes a plurality of blocks arranged serially according broadcast program.

8. The method of claim 7, wherein the searched at least one broadcast program is visually distinguished from other broadcast programs by varying a color of the blocks between the searched at least one broadcast program and the other broadcast programs.

9. The method of claim 7, wherein the searched at least one broadcast program is visually distinguished from other broadcast programs by varying a shape of the blocks between the searched at least one broadcast program and the other broadcast programs.

10. The method of claim 1, wherein the searched at least one broadcast program includes at least one of a previously broadcasted program and a currently broadcasted program.

11. A method of controlling a receiver, the method comprising:
extracting electronic program guide (EPG) information from a received broadcast signal, the EPG information indicating a broadcasting schedule for a plurality of broadcast programs;
first searching at least one broadcast program of the plurality of broadcast programs, the first searched at least one broadcast program corresponding to a permanent storage of the received broadcast signal in a first storage device;
second searching at least one broadcast program of the plurality of broadcast programs, the second searched at least one broadcast program corresponding to a temporary storage of the received broadcast signal in a second storage device enabling a time-shift function; and
constructing an EPG in which the first searched at least one broadcast program, the second searched at least one broadcast program, and other broadcast programs of the plurality of broadcast programs are visually distinguishable from one another.

12. The method of claim 11, wherein the first searched at least one broadcast program, the second searched at least one broadcast program, and other broadcast programs of the plurality of broadcast programs are visually distinguished from one another in accordance with a storage sequence and a storage length of the searched at least one broadcast program stored in the storage device.

13. The method of claim 11, further comprising:
displaying the constructed EPG on a screen of the receiver in accordance with a user request.

14. The method of claim 11, further comprising:
outputting the constructed EPG to a display device separate from the receiver in accordance with a user request.

15. The method of claim 11, wherein the temporary storage corresponds to less than two hours of the received broadcast signal.

16. The method of claim 11, further comprising:
storing the constructed EPG in a memory.

17. The method of claim 11, wherein the constructed EPG includes a plurality of blocks arranged serially according broadcast program.

18. The method of claim 17, wherein the first searched at least one broadcast program, the second searched at least one broadcast program, and other broadcast programs of the plurality of broadcast programs are visually distinguished from one another by varying a color of the blocks between the first searched at least one broadcast program, the second searched at least one broadcast program, and other broadcast programs of the plurality of broadcast programs.

19. The method of claim 17, wherein the first searched at least one broadcast program, the second searched at least one broadcast program, and other broadcast programs of the plurality of broadcast programs are visually distinguished from one another by varying a shape of the blocks between the first searched at least one broadcast program, the second searched at least one broadcast program, and other broadcast programs of the plurality of broadcast programs.

20. The method of claim 11, wherein the first searched at least one broadcast program and the second searched at least one broadcast program include at least one of a previously broadcasted program and a currently broadcasted program.

21. The method of claim 20, wherein the currently broadcasted program is highlighted in the EPG.

22. A receiver, comprising:
a tuner for receiving a broadcast signal;
a controller for extracting electronic program guide (EPG) information from the received broadcast signal, the EPG information indicating a broadcasting schedule for a plurality of broadcast programs, and for searching at least one broadcast program of the plurality of broadcast programs, the searched at least one broadcast program corresponding to a temporary storage of the received broadcast signal in a storage device enabling a time-shift function; and
an EPG generator for constructing an EPG, using the EPG information, in which the searched at least one broadcast program is visually distinguishable from other broadcast programs of the plurality of broadcast programs.

23. The receiver of claim 22, further comprising:
a display for displaying the constructed EPG in accordance with a user request.

24. The receiver of claim 22, wherein said controller outputs the constructed EPG to a display device separate from the receiver in accordance with a user request.

25. The receiver of claim 22, wherein the temporary storage corresponds to less than two hours of the received broadcast signal.

26. The receiver of claim 22, further comprising:
a memory for storing the constructed EPG.

27. A receiver, comprising:
a tuner for receiving a broadcast signal;
a controller for extracting electronic program guide (EPG) information from a received broadcast signal, the EPG information indicating a broadcasting schedule for a plurality of broadcast programs, for first searching at least one broadcast program of the plurality of broadcast programs, and for second searching at least one broadcast program of the plurality of broadcast programs, the first searched at least one broadcast program corresponding to a permanent storage of the received broadcast signal in a first storage device and the second searched at least one broadcast program corresponding to a temporary storage of the received broadcast signal in a second storage device enabling a time-shift function; and
an EPG generator for constructing an EPG in which the first searched at least one broadcast program, the second searched at least one broadcast program, and other broadcast programs of the plurality of broadcast programs are visually distinguishable from one another.

28. The receiver of claim 27, further comprising:
a display for displaying the constructed EPG in accordance with a user request.

29. The receiver of claim 27, wherein said controller outputs the constructed EPG to a display device separate from the receiver in accordance with a user request.

30. The receiver of claim 27, wherein the temporary storage corresponds to less than two hours of the received broadcast signal.

31. The receiver of claim 27, further comprising:
a memory for storing the constructed EPG.
